(19) United States
(12) Patent Application Publication
(10) Pub. No.: US 2022/0388268 A1
(43) Pub. Date: Dec. 8, 2022

(54) RAZER

(71) Applicant: JIA-HUEY YANG, Fenyuan Township (TW)

(72) Inventors: JIA-HUEY YANG, Fenyuan Township (TW); YU-EN HUNG, Fenyuan Township (TW); YU-LUN HUNG, Fenyuan Township (TW); YUAN-TUNG HUNG, Fenyuan Township (TW)

(21) Appl. No.: 17/387,010

(22) Filed: Jul. 28, 2021

(30) Foreign Application Priority Data
Jun. 4, 2021 (TW) 110120398

(51) Int. Cl. B31D 5/04; B26B 21/40; B26B 21/52

(52) U.S. Cl. CPC B31D 5/04; B26B 21/4012; B26B 21/528

(57) ABSTRACT

A razer includes a main body, formed by folding a sheet material. The main body includes two holding portions for the user to hold thereon. One end of the main body includes a blade securement portion and is formed of an opening hole. In addition, a blade is attached to the blade securement portion and is partially exposed out of the opening hole. Before folding, the sheet material is a single flat sheet, and after folding, it can be folded into a three-dimensional razor for use.

### BACKGROUND OF THE INVENTION

### 1. Technical Field

The present invention is related to a razer, and in particular, a razer having a simple structure and convenient for carrying.

### 2. Description of Related Technology

For personal hygiene, presently, the razors provided by accommodation places, such as hotel, motel or camping site, to customers for use are mostly disposable products for one-time use only. Accordingly, based on the cost concern, a lot of business operators mostly provide plastic products of low cost to customers for use. Although such products are able to achieve the purpose of convenient use for customers, nonetheless, the disposable method of one-time use only can cause waste of resource. Furthermore, plastic is a material that cannot be decomposed easily, and large amount of disposal of plastic can also cause burden to the environment.

In view of the above, a razor made from folding paper is known to have been proposed earlier, as shown in FIG. 1 and FIG. 2. This type of razor is based on the use of a sheet material 1. The sheet material has a central folding line 2 and two divisional lines 3. The sheet material 1 includes an opening 4, and the opening 4 includes a blade 5 disposed thereon. The sheet material 1 is folded at two sides along the central folding line 2 and toward the same direction, such that the two sides of the central folding line 2 become a holding portion 6. The two divisional folding lines 3 extend toward two sides of the sheet material 1 at the front end of the central folding line 2 such that a blade securement portion 7 is formed between the two divisional folding lines 3. As a result, the sheet material 1 can be used to fold into a three-dimensional razor use, thereby achieving the demand for environmental protection and friendliness. Despite that such product has the basic function, nevertheless, there are still drawbacks associated with the use thereof. Since the holding portion 6 is only supported by one single central folding line 2, its structural strength is insufficient, and it is likely to bend and deform, making it difficult to use.

### BRIEF SUMMARY OF THE INVENTION

A primary objective of the present invention is to provide a razor such that it is convenient to use and facilitated for carrying, and is also capable of reducing burden to the environment.

To achieve the aforementioned primary objective, a razor of the present invention comprises: a main body formed by folding a sheet material; the sheet material includes a first folding line, two third folding lines symmetrical to each other at left and right sides and two fifth folding lines. The first folding line is formed at the center of the sheet material and extends from one end of the sheet material toward another end thereof. The two third folding lines extend obliquely from the first folding line toward two left and right opposite sides of the sheet material. The two fifth folding lines are disposed at two sides of the first folding line and extend from a rear end of the sheet material toward the third folding lines. A blade securement portion is formed between the two third folding lines. The blade securement portion includes an opening hole penetrating through the two front and rear sides. A blade is attached to the blade securement portion and is partially exposed out of the opening hole.

From the above, it can be understood that the razor of the present invention utilizes a pre-stamped multiple folding lines in order to allow an eco-friendly sheet material to be folded in a simple and fast manner, such that a three-dimensional razor can be formed after folding. Accordingly, the razor of the present invention is convenient to use and is facilitated for carrying while being able to effectively reduce burden to the environment.

Preferably, the sheet material can be made of paper or other biodegradable materials.

Preferably, the blade securement portion further includes a reinforcement portion connected to a front side edge of the blade securement portion and folded along a fourth folding line to be attached to the blade securement portion, thereby allowing the blade to be held between the blade securement portion and the reinforcement portion in order to form a sandwich-like structure.

Preferably, the blade securement portion further includes two reinforcement portions connected to two left and right ends of a front side edge of the blade securement portion, and are respectively folded along a fourth folding line to be attached to the blade securement portion and covering two sides of the blade, thereby allowing the blade to be held between the blade securement portion and the reinforcement portions in order to form a sandwich-like structure.

Details of the structure, features, assembly or use method of the present invention will be further described in the following embodiments and practice methods. However, a person with ordinarily skilled in the art in the technical field of the present invention shall understand that the detailed description and specific embodiments for the practice of the present invention described are provided to illustrate the present invention only such that they shall not be treated as limitations to the scope of the claims of the present invention.

### BRIEF DESCRIPTION OF THE SEVERAL VIEWS OF THE DRAWINGS

FIG. 1 shows an unfolded layout of a known sheet material product;

FIG. 2 is a perspective view of a known sheet material product;

FIG. 3a and FIG. 3b show unfolded layouts of a sheet material used by a razor according to the first embodiment of the present invention;

FIG. 4 is a perspective view of the first embodiment of the present invention;

FIG. 5 is a perspective view of the first embodiment of the present invention viewed from another direction;

FIG. 6 is a rear view of the first embodiment of the present invention;

FIG. 7 shows a unfolded layout of a sheet material used by a razor according to the second embodiment of the present invention;

FIG. 8 shows a unfolded layout of a sheet material used by a razor according to the third embodiment of the present invention;

FIG. 9 is a schematic view of the third embodiment with the reinforcement portion being folded;

FIG. 10 shows a unfolded layout of a sheet material used by a razor according to the fourth embodiment of the present invention;

FIG. 11 is a perspective view of a razor according to the fourth embodiment of the present invention;

FIG. 12 shows a unfolded layout of a sheet material used by a razor according to the fifth embodiment of the present invention; and

FIG. 13 is a perspective view of a razor according to the fifth embodiment of the present invention.

### DETAILED DESCRIPTION OF THE INVENTION

The applicant emphasizes that for this specification as a whole, including the following embodiments described and the claims applied, all directional terms are described based on the directions shown in the drawings. Furthermore, for the embodiments and drawings described, identical component signs are used to represent identical or similar components or structural features of the present invention.

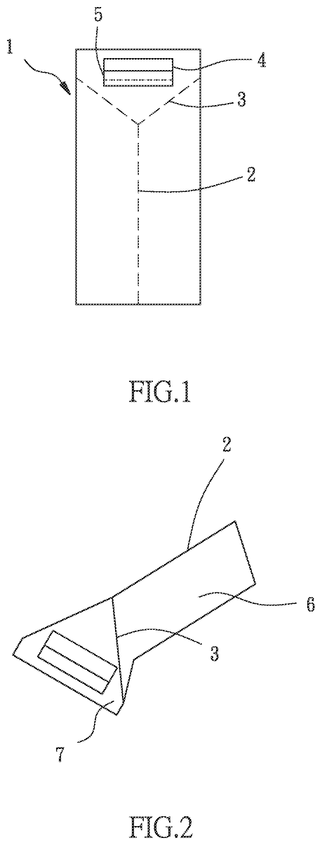

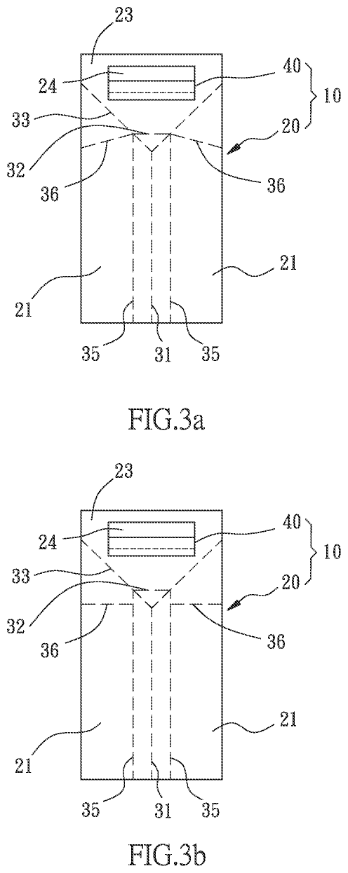

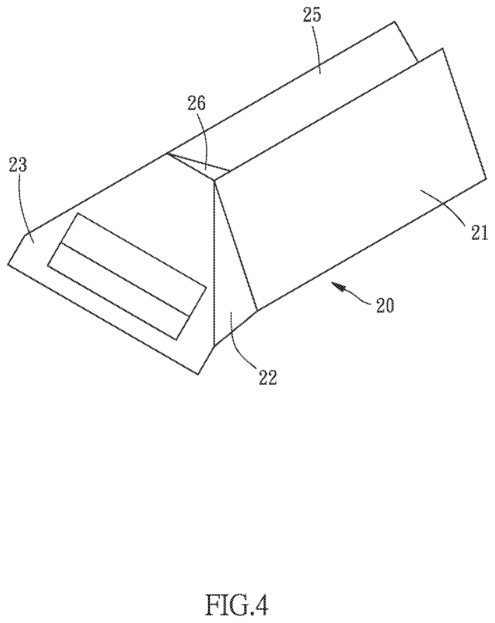

First, please refer to FIG. 1 to FIG. 4 showing a razor 10 according to the first embodiment of the present invention, comprising a main body 20 and a blade 40.

The main body 20 is formed by folding a sheet material 30. In this embodiment, the sheet material 30 uses a rectangular paper of 100 lb˜300 lb. In addition, according to the actual needs, the outer surface can use coating or lamination method to form a layer of plastic film formed by, such as polyethylene (PE) or polyethylene terephthalate (PET) material, such that the sheet material 30 has the waterproof effect; however, the present invention is not limited to such material only. Preferably, the sheet material can be made of eco-friendly materials, such as paper or other biodegradable materials, and the shape of such sheet material is not limited to any specific shape.

The sheet material 30 includes a first folding line 31, a second folding line 32, two third folding lines 33 symmetrical to each other at left and right sides, two fifth folding lines 35 and two auxiliary lines 36. All of these folding lines can be formed via stamping. The first folding line 31 extends from the rear end of the sheet material 30 toward the front end thereof. The second folding line 32 is horizontally arranged at the front of the front end of the first folding line 31. The two third folding lines 33 extend obliquely from the front end of the first folding line 31 toward two left and right opposite sides of the sheet material 30. The two fifth folding lines 35 are disposed at two left and right sides of the first folding line 31 and extend from the rear end of the sheet material 30 toward the front end thereof to connect to an intersection between the second folding line 32 and the third folding lines 33. The two auxiliary lines 36 are respectively formed at two sides of the second folding line 32 and extend to two opposite sides of the sheet material 30.

After folding, the two sides of the first folding line 31 are folded toward one identical direction along the first folding line 31, and then, the sheet material is folded along the two fifth folding lines 35 toward the opposite direction, such that a first slanted supporting portion 25 having a M-shaped structure is respectively formed between the first folding line 31 and the two fifth folding lines 35. In addition, a second slanted supporting portion 26 is formed between the second folding line 32 and the two third folding lines 33. A blade securement portion 23 is formed between the two third folding lines 33. The two slanted supporting portion 26 are connected to the blade securement portion 23 and the two first slanted supporting portions 25. The sheet material 30 includes two holding portions 21 respectively formed at the outer sides of the two fifth folding lines in order to allow the user to hold thereon. In addition, the formation of the M-shaped structure is able to effectively prevent bending and deformation of the holding portions 21, thereby enhancing the structural strength of the entire holding portions 21.

Furthermore, the two auxiliary lines 36 and the two third folding lines 33 are folded to form two supporting portions 22 and the blade securement portion 23. The two supporting portions 22 are located between the auxiliary lines 36 and the third folding lines 33 and are also symmetrical to each other at left and right sides with respect to the first folding line 31. The two supporting portions 22 are connected to one of the holding portions 21 respectively. The blade securement portion 23 is formed between the two third folding lines 33 and connected to the two supporting portions 22, thereby allowing the two supporting portions 22 to achieve the supporting effect for the blade securement portion 23. In addition, the blade securement portion 23 includes an opening hole 24 penetrating through the two front and rear sides. The blade 40 is arranged at the blade securement portion 23 and is partially exposed out of the opening hole 24. The shape of the aforementioned opening hole 24 is not limited to any specific shapes (a rectangular shape is used here as an example for illustration) as long as the blade 40 is able to expose appropriately.

Furthermore, to further enhance the stability of the blade 40, the blade securement portion 23 can have different structural variations. In a second embodiment of the present invention, the blade securement portion 23 further includes a reinforcement portion 27. As shown in FIG. 5, the reinforcement portion 27 is connected to a front side edge of the blade securement portion 23 and is folded along a fourth folding line 34 to be attached to the blade securement portion 23. The reinforcement portion 27 is configured to cover on the blade 40 and includes an opening 28 formed corresponding to the opening hole 24, thereby allowing the blade 40 to be held between the blade securement portion 23 and the reinforcement portion 27 in order to form a sandwich-like structure. In this embodiment, the shape and size of the reinforcement portion 27 are identical to those of the blade securement portion 23; however, it is not limited to such shape and size only, and the reinforcement portion can also have shape and size identical to those of the sheet material 30.

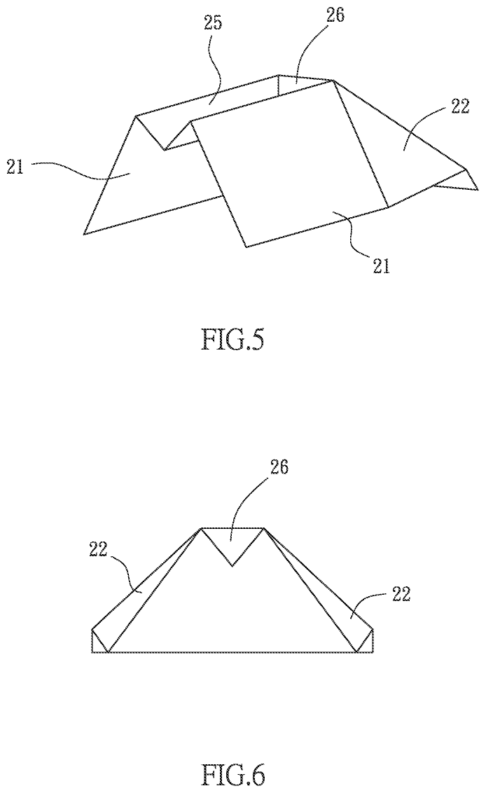

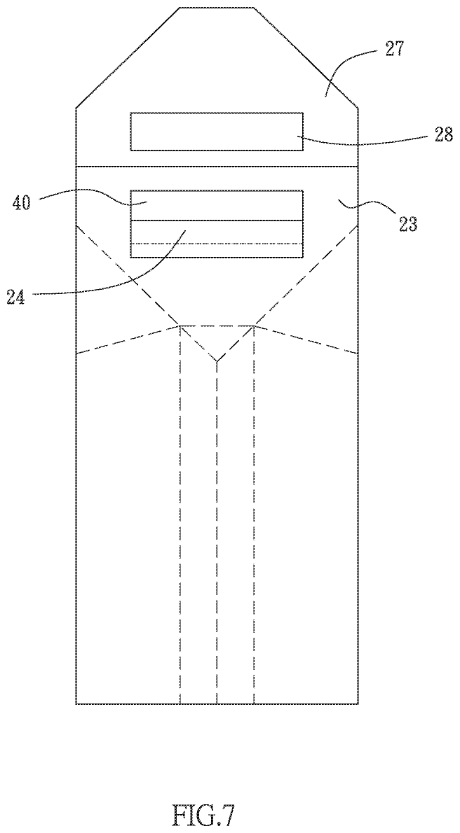

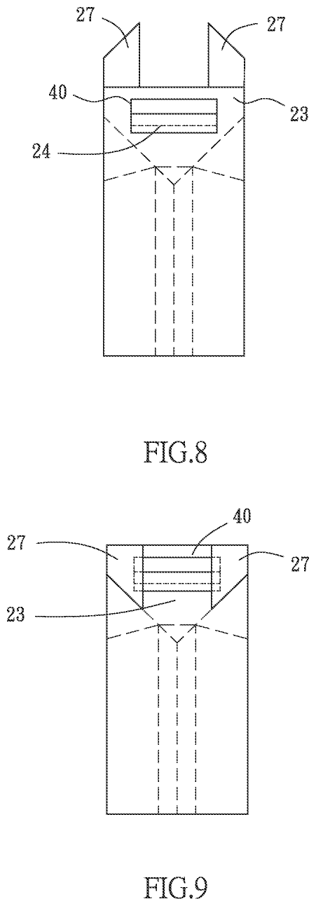

Moreover, the quantity of the reinforcement portion 27 can also be increased to two. In a third embodiment of the present invention, as shown in FIG. 6 and FIG. 7, two reinforcement portions 27 are connected to two left and right ends of a front side edge of the blade securement portion 23. The two reinforcement portions 27 are respectively folded along a fourth folding line 34 to be attached to the blade securement portion 23 and covering two sides of the blade 40, thereby allowing the blade 40 to be held between the blade securement portion 23 and two reinforcement portions 27 in order to form a sandwich-like structure such that the stability of the blade is increased.

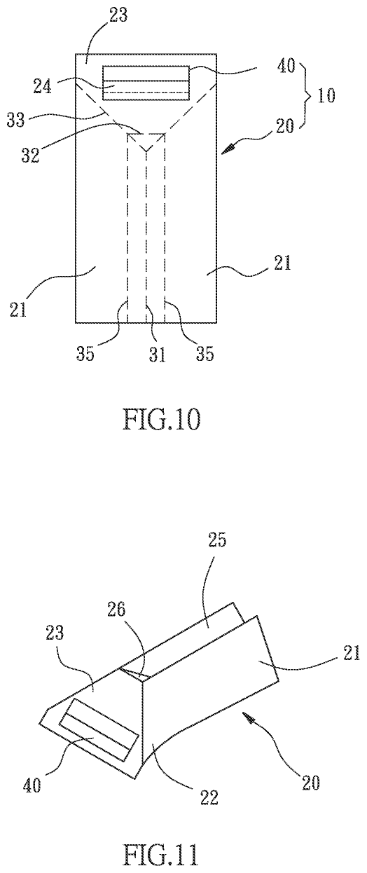

Furthermore, please refer to FIG. 10 and FIG. 11, showing a fourth embodiment of the present invention. In this embodiment, the sheet material 30 includes a first folding line 31, a second folding line 32, two third folding lines 33 symmetrically to each other at left and right sides and two fifth folding lines 35. Similarly, the sheet material also includes an opening hole 24, and a blade 40 is arranged at the opening hole 24. The difference between this embodiment and the first embodiment relies in that in this embodiment, the sheet material 30 does not include the two auxiliary lines 36. In other words, the auxiliary lines 36 can be removed from the configuration. The portion where the two third folding lines 33 are connected to the two holding portions 21 would not form obvious folding lines; nevertheless, such arrangement does not affect the function and effect of the sheet material 30 forming a three-dimensional razor.

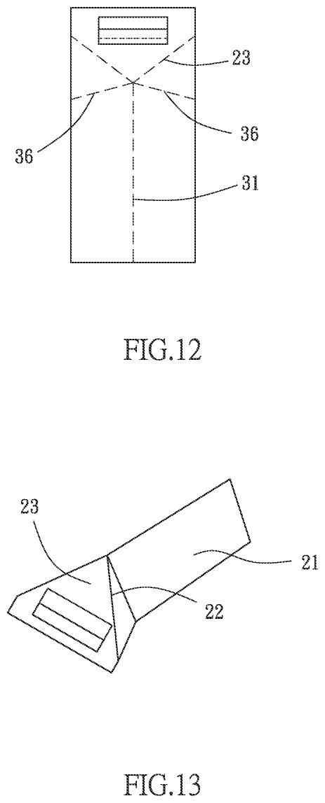

Furthermore, please refer to FIG. 12 and FIG. 13, showing a fifth embodiment of the present invention. In this embodiment, the sheet material 30 includes a first folding line 31, two third folding lines 33 symmetrically to each other at left and right sides and two auxiliary lines 36. The difference between this embodiment and the first embodiment relies in that in this embodiment, there are no second folding line 32 and the two fifth folding lines 35. In this embodiment, the two third folding lines 33 and the two auxiliary lines 36 are utilized to auxiliary support the two sides of the sheet material 30, such that it is able to improve the condition where the blade securement portion 23 tends to be bend easily in terms of the structure of the product.

In view of the above, the razor 10 of the present invention is able to utilize multiple folding lines formed via pre-stamping method in order to allow the sheet material 30 to be able to form into a three-dimensional razor available for use easily and swiftly through folding from a planar sheet material. Accordingly, the razor of the present invention is convenient to use and facilitated for carrying while being able to reduce the use of plastic such that the burden to the environment is also reduced.

What is claimed is:

1. A razor, comprising:
a main body formed by folding a sheet material, and the sheet material comprising: a first folding line 31, a second folding line 32, two third folding lines 33 symmetrical to each other at left and right sides and two fifth folding lines 35; the first folding line 31 extending from one end of the sheet material 30 toward another end thereof; the two third folding lines 33 extending obliquely from the first folding line 31 toward two left and right opposite sides of the sheet material 30; the two fifth folding lines 35 disposed at two left and right sides of the first folding line 31 and extending from a rear end of the sheet material 30 toward a front end thereof to connect to the third folding lines 33; a first slanted supporting portion 25 having a M-shaped structure respectively formed between the first folding line 31 and the two fifth folding lines 35; a blade securement portion 23 formed between the two third folding lines 33; the blade securement portion 23 having an opening hole 24 penetrating through the two front and rear sides; the sheet material 30 having two holding portions 21 formed at outer sides of the two fifth folding lines respectively to allow a user to hold thereon; the two folding lines arranged horizontally in front of a front end of the first folding line 31; the two fifth folding lines 35 extending from the rear end of the sheet material 30 toward the front end to connect to an intersection between the second folding line 32 and the third folding lines 33; and
a blade arranged at the blade securement portion 23 and partially exposed out of the opening hole 24.

2. The razor according to claim 1, wherein a second slanted supporting portion 26 is formed between the second folding line 32 and the two third folding lines 33.

3. The razor according to claim 2, further comprising two auxiliary lines 36 respectively formed at two sides of the second folding line 32 and extend to two opposite sides of the sheet material 30.

4. The razor according to claim 3, wherein the two auxiliary lines 36 and the two third folding lines 33 are folded to form two supporting portions 22.

5. The razor according to claim 3, wherein the horizontal folding lines 36 at two left and right sides are located at front ends of the left and right folding lines 35 with an equal distance away from each other and further extend toward two sides of the sheet material, in order to form the two supporting portions 22.

6. The razor according to claim 5, wherein the blade securement portion 23 further includes a reinforcement portion 27 connected to a front side edge of the blade securement portion 23 and folded along a fourth folding line 34 to be attached to the blade securement portion 23; the reinforcement portion 27 is configured to cover on the blade 40 and includes an opening 28 formed corresponding to the opening hole 24, thereby allowing the blade 40 to be held between the blade securement portion 23 and the reinforcement portion 27 in order to form a sandwich-like structure.

7. The razor according to claim 4, wherein the blade securement portion 23 further includes a reinforcement portion 27 connected to a front side edge of the blade securement portion 23 and folded along a fourth folding line 34 to be attached to the blade securement portion 23; the reinforcement portion 27 is configured to cover on the blade 40 and includes an opening 28 formed corresponding to the opening hole 24, thereby allowing the blade 40 to be held between the blade securement portion 23 and the reinforcement portion 27 in order to form a sandwich-like structure.

8. The razor according to claim 4, wherein the blade securement portion further includes two reinforcement portions 27 connected to two left and right ends of a front side edge of the blade securement portion 23; the two reinforcement portions 27 are respectively folded along a fourth folding line 34 to be attached to the blade securement portion 23 and covering two sides of the blade 40, thereby allowing the blade 40 to be held between the blade securement portion 23 and the two reinforcement portions 27 in order to form a sandwich-like structure.

9. A razor, comprising:
a main body formed by folding a sheet material, and the sheet material comprising: a first folding line 31, two third folding lines 33 symmetrical to each other at left and right sides and two auxiliary folding lines 36; the first folding line 31 extending from one end of the sheet material 30 toward another end thereof; the two third folding lines 33 extending obliquely from the first folding line 31 toward two left and right opposite sides of the sheet material 30; a bade securement portion 23 arranged between the two third folding lines; the two auxiliary lines 36 respectively formed at two sides of the first folding line 31 and extending to two opposite sides of the sheet material 30; the blade securement portion 23 having an opening hole 24 penetrating through the two front and rear sides; the sheet material 30 having a holding portion 21 respectively formed at two sides of the first folding line 31 to allow a user to hold thereon; and
a blade arranged at the blade securement portion 23 and partially exposed out of the opening hole 24

10. The razor according to claim 9, wherein the two auxiliary lines 36 and the two third folding lines 33 are folded to form two supporting portions 22 and the blade securement portion 23; the two supporting portions 22 are located between the auxiliary lines 36 and the third folding lines 33 and are also symmetrical to each other at left and right sides with respect to the first folding line 31; the two supporting portions 22 are connected to each one of the holding portions 21 respectively.
